(19) United States
(12) Patent Application Publication
(10) Pub. No.: US 2016/0334364 A1
(43) Pub. Date: Nov. 17, 2016

(54) GEL FOR USE IN POLYACRYLAMIDE GEL ELECTROPHORESIS AND ELECTROPHORESIS DEVICE USING SAID GEL

(71) Applicant: SHARP KABUSHIKI KAISHA, Osaka-shi, Osaka (JP)

(72) Inventors: Hideki KINOSHITA, Osaka-shi (JP); Kimihiko YABE, Osaka-shi (JP); Yoshiyuki ISHIDA, Osaka-shi (JP)

(73) Assignee: Sharp Kabushiki Kaisha, Osaka-shi, Osaka (JP)

(21) Appl. No.: 15/103,362

(22) PCT Filed: Dec. 4, 2014
(86) PCT No.: PCT/JP2014/082106

§ 371 Date: Jun. 10, 2016

(30) Foreign Application Priority Data
Dec. 16, 2013 (JP) 2013-259571

(51) Int. Cl. G01N 27/447

(52) U.S. Cl. CPC G01N 27/44747; G01N 27/44778

(57) ABSTRACT

There are provided (i) a gel for use in polyacrylamide gel electrophoresis which gel produces a concentration effect for a longer time period and prevents heat generation during migration and (ii) an electrophoresis apparatus provided with the gel. A gel according to the present invention for use in polyacrylamide gel electrophoresis includes a concentration gel and a separation gel having a pH adjusted to a value different from the pH value of the concentration gel, an acrylamide buffer being covalently bonded to at least one of the concentration gel and the separation gel.

### TECHNICAL FIELD

The present invention relates to a gel for use in polyacrylamide gel electrophoresis and to an electrophoresis apparatus provided with the gel. More specifically, the present invention relates to (i) a gel for use in polyacrylamide gel electrophoresis which gel contains a concentration gel and a separation gel having a pH adjusted to a value different from the pH value of the concentration gel and to (ii) an electrophoresis apparatus provided with the gel.

### BACKGROUND ART

Sodium dodecyl sulfate-polyacrylamide gel electrophoresis (SDS-PAGE) is a protein analysis method that utilizes the fact that treating protein with SDS as a surface active agent causes the SDS to be bonded to the protein at a quantity ratio (1:1.4) corresponding to the molecular weight of the protein. An SDS-protein complex, in which SDS is bonded to protein, is negatively charged due to an SO₄²⁻ group (hydrophilic ion group) contained in an SDS molecule. Thus, passing a current through a gel for use in polyacrylamide gel electrophoresis (hereinafter also referred to simply as “gel”) causes the SDS-protein complex in the gel to migrate to the anode. When the SDS-protein complex moves through the gel, the protein, which has a smaller molecular weight, moves more rapidly, as the gel serves as a molecular sieve. This indicates that the mobility of the protein allows for calculation of an apparent molecular weight of the protein.

A typical gel for use in SDS-PAGE is a two-layer gel including two layers different from each other in terms of the gel concentration and the pH of the buffer solution contained. The two layers correspond respectively to, as disclosed in Non Patent Literature 1, (i) a gel positioned upstream in the migration direction and containing a tricine buffer solution having a pH of 6.8 and (ii) a gel positioned downstream of the above gel in the migration direction and containing a tricine buffer solution having a pH of 8.8.

The gel positioned upstream in the migration direction and having a pH of 6.8 does not separate out but concentrates protein in the protein sample (SDS-protein complex). The gel positioned upstream in the migration direction and having a pH of 6.8 is thus called concentration gel (or stacking gel). The gel positioned downstream in the migration direction and having a pH of 8.8, on the other hand, separates out protein molecules on the basis of their molecular weights, and is called separation gel.

The concentration gel, which has a pH of 6.8, allows for migration in order of migration speed (rapidness in movement through the gel), specifically in the following order: (i) chlorine ions contained in a cathode buffer of a migration buffer solution for the cathode, (ii) the protein sample, and (iii) glycine contained in the cathode buffer. The glycine contained in the cathode buffer has a degree of dissociation of approximately 10% in a concentration gel containing a buffer solution having a pH of 6.8, and thus moves to the anode slowly. The chlorine ions contained in the cathode buffer, on the other hand, moves to the anode rapidly. During this movement, the resistance becomes higher between the chlorine ions and the glycine than any other portion, and increases the voltage. This causes the protein sample migrating between the chlorine ions and the glycine to be concentrated at the boundary of the chlorine ions at the tip.

The concentration gel concentrating the protein sample as described above allows the separation gel to separate out the protein sample better. This makes it possible to detect a sharp band in the separation gel.

### CITATION LIST

### Non Patent Literature 1

Protein Experimental Notebook, Last Volume, From Separation and Identification to Functional Analysis, Revised Third Edition, Yodosha Co., Ltd., edited by Masato Okada and Kaoru Miyazaki

### SUMMARY OF INVENTION

### Technical Problem

A gel for electrophoresis which gel includes two gels that contain respective buffer solutions different from each other in pH and that are in contact with each other as described above is, however, problematic in that the buffer solutions become mixed over time. Passage of time causes the buffer solution of the separation gel to be mixed with the concentration gel, which causes the concentration gel to lose its concentration effect and significantly decreases the resolution of separation of the protein sample. This requires a person who carries out migration to prepare a gel each time the person carries out migration. There is therefore a demand for development of a gel for use in polyacrylamide gel electrophoresis which gel maintains the concentration effect of a concentration gel even after passage of time.

Further, the respective buffer solutions contained in the concentration gel and the separation gel are electrically charged under the above pH conditions, and are moved upon voltage application. This leads to a high current value to be detected in the gel and generates heat. Heat generation causes the gel to swell, which results in a poor electrophoresis separation pattern.

### Solution to Problem

The inventors of the present invention have, in view of the above, successfully developed a gel for use in polyacrylamide gel electrophoresis which gel allows a protein sample to be concentrated before migration into a separation gel, maintains a concentration effect over a longer time period, and prevents heat generation during migration. The inventors have thereby completed the present invention.

In other words, it is an object of the present invention to provide (i) a gel for use in polyacrylamide gel electrophoresis which gel produces a concentration effect over a longer time period and prevents heat generation during migration and (ii) an electrophoresis apparatus provided with the gel.

Specifically, in order to solve the above problems, a gel according to an aspect of the present invention for use in polyacrylamide gel electrophoresis is a gel for use in polyacrylamide gel electrophoresis, the gel including: a concentration gel; and a separation gel having a pH adjusted to a value different from a value of a pH of the concentration gel, an acrylamide buffer being covalently bonded to at least one of the concentration gel and the separation gel.

In order to solve the above problems, an electrophoresis apparatus according to an aspect of the present invention is an electrophoresis apparatus, including: the gel; a cathode; an anode provided opposite to the cathode with respect to the gel; and a cathode buffer to be added to a portion of the gel which portion is on a side of the cathode.

### Advantageous Effects of Invention

An aspect of the present invention makes it possible to provide a gel for use in polyacrylamide gel electrophoresis in which gel an acrylamide buffer is fixed to a polyacrylamide gel to prevent the acrylamide buffer from being diffused over time and allow the concentration gel to produce a concentration effect over a longer time period. Further, an aspect of the present invention makes it possible to provide a gel for use in polyacrylamide gel electrophoresis in which gel the amount of an acrylamide buffer moved is decreased to prevent heat generation and improve the resolving power. In addition, an aspect of the present invention makes it possible to provide an electrophoresis apparatus provided with the gel, which gel makes it possible to product a concentration effect over a longer time period and prevent heat generation during migration.

### BRIEF DESCRIPTION OF DRAWINGS

FIG. 1 is a perspective view of an instrument configured to prepare an embodiment of a gel according to the present invention for use in polyacrylamide gel electrophoresis.

FIG. 2 is a perspective view of the instrument illustrated in FIG. 1, the perspective view illustrating how a gel of an embodiment of the present invention for use in polyacrylamide gel electrophoresis is prepared in the instrument.

FIG. 3 is a diagram schematically illustrating an embodiment of a gel according to the present invention for use in polyacrylamide gel electrophoresis, the diagram illustrating how an acrylamide buffer is covalently bonded to the gel.

FIG. 4 provides diagrams each illustrating an automated two-dimensional electrophoresis apparatus as an embodiment of an electrophoresis apparatus according to the present invention.

FIG. 5 is a diagram illustrating an automated two-dimensional electrophoresis apparatus as an embodiment of an electrophoresis apparatus according to the present invention.

FIG. 6 provides images illustrating respective separation patterns obtained in (i) an Example involving use of an embodiment of a gel according to the present invention for use in polyacrylamide gel electrophoresis and (ii) a Comparative Example.

FIG. 7 provides images illustrating respective separation patterns obtained in (i) an Example involving use of an embodiment of a gel according to the present invention for use in polyacrylamide gel electrophoresis and (ii) a Comparative Example.

### DESCRIPTION OF EMBODIMENTS

### Embodiment 1

The description below deals with an embodiment of a gel according to the present invention for use in polyacrylamide gel electrophoresis, an embodiment of a method for preparing the gel, and an embodiment of an electrophoresis apparatus provided with the gel.

[1] Gel for Use in Polyacrylamide Gel Electrophoresis

A gel according to the present invention for use in polyacrylamide gel electrophoresis contains (i) a concentration gel (stacking gel) that does not separate out but concentrates protein and (ii) a separation gel that has a pH adjusted to a value different from the pH value of the concentration gel and that separates out protein. The gel of the present invention for use in polyacrylamide gel electrophoresis may further contain a gel (layer) in addition to the concentration gel and the separation gel.

Embodiment 1 separates out a protein sample by electrophoresis. The sample is, however, not limited to protein. The sample is either (i) a mixture of a plurality of unique molecular species that can be separated out with use of gel electrophoresis or (ii) a single substance that is localized at a position in the gel as a result of gel electrophoresis. Specific examples of the sample include preparations of biological materials (for example, an individual organism, a body fluid, a cell strain, a tissue culture, and a tissue fragment) and commercially available reagents. Examples include polypeptides and polynucleotides.

The gel of Embodiment 1 for use in polyacrylamide gel electrophoresis is a denaturing gel containing SDS as a surface active agent. The present invention is, however, not limited to a denaturing gel containing SDS, and may be a denaturing gel containing a surface active agent other than SDS as a surface active agent that shows a denaturing action. Further, the present invention may be a denaturing gel containing a substance (for example, urea or formaldehyde) that shows a denaturing action and that is other than a surface active agent. In addition, the gel according to the present invention for use in polyacrylamide gel electrophoresis may be a non-denaturing gel. A non-denaturing gel is a gel for use in polyacrylamide gel electrophoresis which gel contains no denaturating agent. A non-denaturing gel (that is, a native gel) is used in native gel electrophoresis. In this case, neither the running buffer solution nor the sample buffer solution contains a denaturating agent.

The gel of Embodiment 1 for use in polyacrylamide gel electrophoresis is a gel for use in SDS-PAGE. The present invention is, however, applicable not only to SDS-PAGE, and is applicable to polyacrylamide gel electrophoresis in general including SDS-PAGE.

The gel of Embodiment 1 for use in polyacrylamide gel electrophoresis may have any size. The present embodiment assumes that the gel of Embodiment 1 for use in polyacrylamide gel electrophoresis has a thickness in a z direction and that an x direction and a y direction both perpendicular to the z direction define an x-y plane. The gel according to the present invention for use in polyacrylamide gel electrophoresis may have a size that is selected as appropriate depending on, for example, the purpose of the electrophoresis and/or the size of the electrophoresis apparatus. The gel may range in size from, for example, (i) a relatively small size with an area of approximately 10 cm×10 cm on an x-y plane and a thickness of approximately 1 mm to (ii) a relatively large size with an area of approximately 30 cm×30 cm on an x-y plane and a thickness of approximately 1 mm.

The gel of Embodiment 1 for use in polyacrylamide gel electrophoresis is disposed between a pair of electrodes of an electrophoresis apparatus described later. Applying a voltage to the electrodes causes a current to flow through the gel. The present embodiment assumes that the direction in which the current flows, that is, the direction of migration of the sample, corresponds to the y direction. Specifically, one of the pair of electrodes (cathode) is positioned upstream in the y direction of the gel of Embodiment 1 for use in polyacrylamide gel electrophoresis, whereas the other electrode (anode) is positioned downstream in the y direction of the gel. The concentration gel and the separation gel both contained in the gel of Embodiment 1 for use in polyacrylamide gel electrophoresis are disposed such that the concentration gel is upstream of the separation gel in the direction of migration. The concentration gel and the separation gel each have an interface along a direction (x direction) perpendicular to the direction of migration.

The gel according to Embodiment 1 for use in polyacrylamide gel electrophoresis is characterized in that an acrylamide buffer is covalently bonded to the concentration gel and the separation gel. Other conditions for the gel for use in polyacrylamide gel electrophoresis (for example, the volume of the concentration gel, the volume of the separation gel, and the position in the gel of the interface) may be selected as appropriate with reference to conventionally well-known gels for use in SDS-PAGE.

The polyacrylamide for the gel for use in polyacrylamide gel electrophoresis appearing in the specification of the present application refers to a mixture of an acrylamide monomer and N,N′-methylenebisacrylamide (bis or bisacrylamide). The acrylamide and bis are crosslinked with each other to form a branched molecular structure, which is the gel for use in polyacrylamide gel electrophoresis appearing in the specification of the present application. The covalently bonded acrylamide buffer appearing in the specification of the present application is an acrylamide derivative that shows a buffering action.

—Concentration Gel

The concentration gel contained in Embodiment 1 for use in polyacrylamide gel electrophoresis has a pH adjusted to a value within the range of pH 6.0 to pH 8.8, preferably within the range of pH 6.6 to pH 7.5. The pH of the concentration gel is, for example, adjusted to 6.8. The concentration gel, of which the pH condition is adjusted as such, does not separate out but concentrates protein. The principle of the concentration is well-known, and is not described here.

An acrylamide buffer is covalently bonded to the concentration gel. Since the acrylamide buffer has a vinyl group, the acrylamide monomer can be covalently fixed to the gel.

The acrylamide buffer being covalently bonded to the concentration gel prevents the acrylamide buffer from moving from the concentration gel to the separation gel. This prevents the concentration effect of the concentration gel from decreasing due to time lapse as described earlier, and also prevents heat generation during migration.

The acrylamide buffer to be covalently bonded to the concentration gel may be selected from acrylamide derivatives each having an already known pKa. The acrylamide buffer may, for example, be selected from, but not limited to, one or more buffers represented by the general formula below.

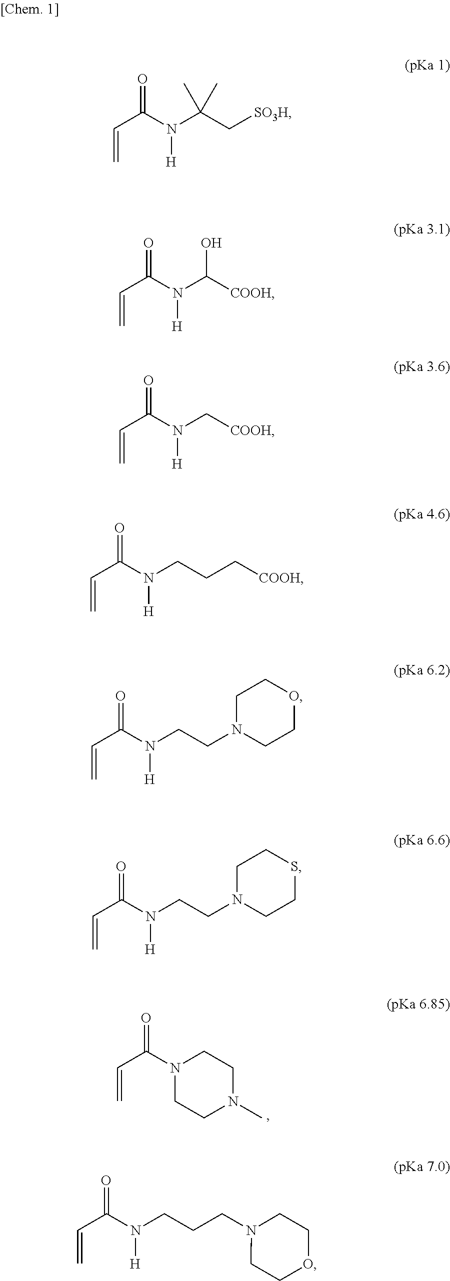

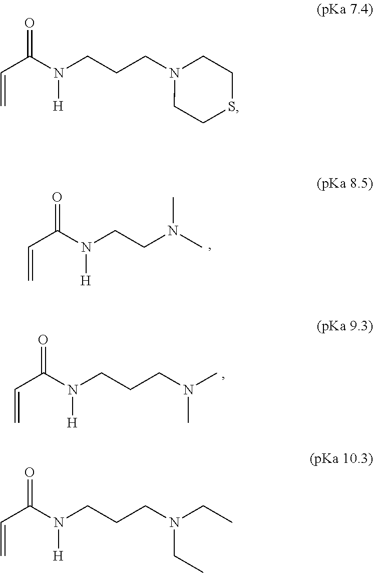

The acrylamide buffer having a pKa within the range of 1.0 to 12.0 is covalently bonded to the concentration gel. Preferably, an acrylamide buffer having a pKa within the range of 6.2 to 8.5 is covalently bonded to the concentration gel. An acrylamide buffer having a pKa within the above range being covalently bonded to the concentration gel allows protein to be between chlorine ions as front ions and glycine as trailing ions to produce the effect of concentrating the protein at the chlorine ion boundary.

The acrylamide buffer covalently bonded to the concentration gel is a buffer agent having a pH adjusted to a value equal to the pH value of a pH buffer solution contained in the concentration gel.

The acrylamide buffer covalently bonded to the concentration gel preferably has a concentration within the range of 50 mM to 200 mM, more preferably within the range of 100 mM to 150 mM. The acrylamide buffer having a concentration within the above range has a preferable buffer capacity and allows for protein concentration.

The concentration gel may, as long as an acrylamide buffer is covalently bonded thereto, have a composition identical to the composition of any conventionally well-known concentration gel. Further, the concentration gel may further contain an additive as long as the additive does not inhibit the function of the concentration gel.

—Separation Gel

The separation gel contained in the gel of Embodiment 1 for use in polyacrylamide gel electrophoresis has a pH adjusted to a value within the range of 8.0 to 9.2, preferably within the range of 8.4 to 8.8. The pH of the separation gel is, for example, adjusted to 8.8. The separation gel, of which the pH condition is adjusted as such, separates out a protein sample concentrated by the concentration gel. The principle of the separation is well-known, and is not described here.

An acrylamide buffer is crosslinked to the separation gel, which prevents the acrylamide buffer from moving from the separation gel to the concentration gel. This prevents the concentration effect of the concentration gel from decreasing due to time lapse as described earlier, and also prevents heat generation during migration.

Specifically, an acrylamide buffer having a pKa within the range of 1.0 to 12.0 is covalently bonded to the separation gel. Preferably, an acrylamide buffer having a pKa within the range of 8.5 to 9.3 is covalently bonded to the separation gel. An acrylamide buffer having a pKa within the above range being covalently bonded to the separation gel allows for a high-resolution separation result.

The acrylamide buffer covalently bonded to the separation gel is a buffer agent having a pH adjusted to a value equal to the pH value of a pH buffer solution contained in the separation gel.

The acrylamide buffer covalently bonded to the separation gel preferably has a concentration within the range of 50 mM to 200 mM, more preferably within the range of 100 mM to 150 mM. The acrylamide buffer having a concentration within the above range has a preferable buffer capacity and allows for protein separation.

The acrylamide buffer to be covalently bonded to the separation gel may be selected from acrylamide derivatives each having an already known pKa. The acrylamide buffer may, for example, be selected from, but not limited to, one or more buffers represented by the general formula below.

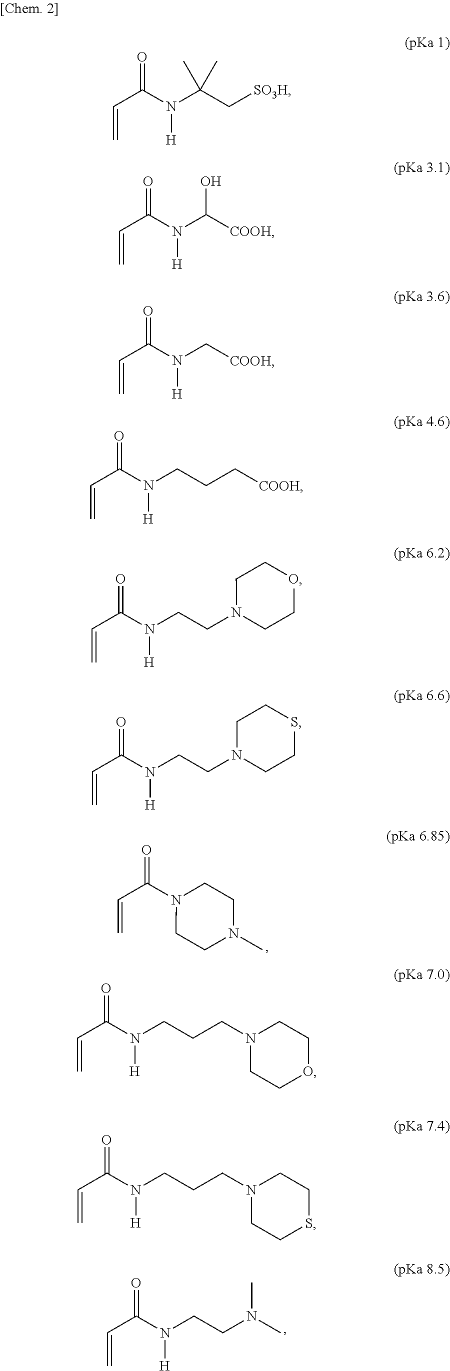

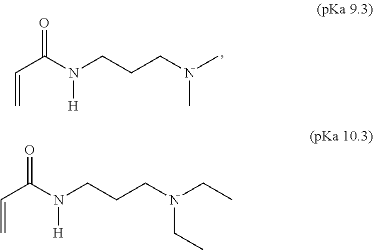

The separation gel may, as long as an acrylamide buffer is covalently bonded thereto, have a composition identical to the composition of any conventionally well-known separation gel. Further, the separation gel may further contain an additive as long as the additive does not inhibit the sample separation of the separation gel.

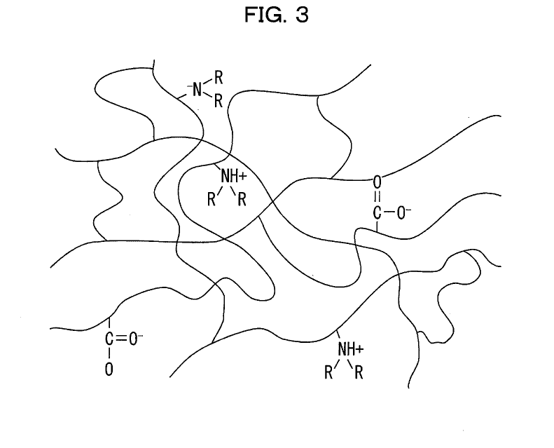

FIG. 3 schematically illustrates a gel to which an acrylamide buffer is covalently bonded. FIG. 3 shows Rs each representing, for example, a carboxyl group or a tertiary amine. The gel for use in polyacrylamide gel electrophoresis illustrated in FIG. 3 contains (i) acrylamide and bisacrylamide that are crosslinked to form a branched molecular structure and (ii) an acrylamide buffer crosslinked (covalently bonded) at the position of the molecular structure.

As described above, the gel of Embodiment 1 for use in polyacrylamide gel electrophoresis contains a concentration gel and a separation gel that contain respective buffer solutions different from each other in pH and that are in contact with each other. Since an acrylamide buffer contained in the pH buffer solution for each of the concentration gel and the separation gel is covalently bonded, the respective buffer solutions are not mixed with each other. This allows for production of a gel for use in polyacrylamide gel electrophoresis for which gel (i) the concentration effect of a concentration gel is not reduced by the buffer solution of a separation gel over time and (ii) the preservability is excellent.

The respective buffer solutions contained in the concentration gel and the separation gel each have an electric charge under the pH condition described above. Embodiment 1 is, however, arranged such that an acrylamide buffer contained as a buffer agent in the buffer solution is covalently bonded. This prevents the buffer solution from moving in the gel in response to voltage application. This in turn prevents an excessive current from flowing through the gel and prevents undesirable heat generation. The above arrangement therefore allows for production of a gel for use in polyacrylamide gel electrophoresis which gel does not become swollen and allows for detection of a good electrophoresis separation pattern.

[2] Method for Preparing Gel for Use in Polyacrylamide Gel Electrophoresis

The gel of Embodiment 1 for use in polyacrylamide gel electrophoresis, which is an SDS-PAGE gel, may be prepared by any conventionally well-known method for preparing an SDS-PAGE gel.

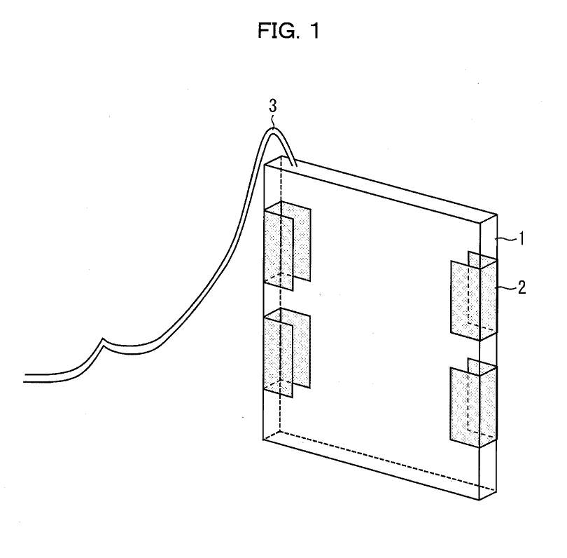

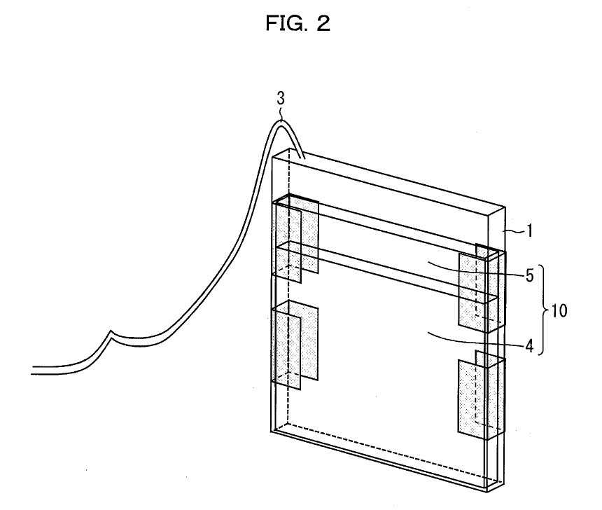

FIGS. 1 and 2 are each a perspective view of an instrument for use in preparation of the gel of Embodiment 1 for use in polyacrylamide gel electrophoresis. FIG. 1 illustrates how two gel plates 1 each including an insulating member have respective gel-formation surfaces placed inside and are fastened with clips 2. The two gel plates 1 are separated from each other by spacers (not shown) to form a gap corresponding to the thickness of the gel of Embodiment 1 for use in polyacrylamide gel electrophoresis. The gap is filled with gel solutions with use of a tube 3. The spacers are positioned at the two lateral sides and the bottom of the two gel plates 1, but not at the top of the two gel plates 1. This allows the gap between the two gel plates 1 to be filled with gel solutions from the top of the two gel plates 1 with use of the tube 3.

Two gel solutions are prepared: a separation gel solution and a concentration gel solution. The separation gel solution is prepared by adding an acrylamide buffer (pKa 8.8) to a conventionally well-known acrylamide monomer solution for a separation gel preparation (with a composition of 9.7% acrylamide, 0.3% bisacrylamide, 375 mM Tris-HCl [pH 8.8], 0.1% TEMED, and 0.05% APS) until the acrylamide buffer has a concentration of 100 mM. The concentration gel solution is prepared by adding an acrylamide buffer (pKa 6.8) to a conventionally well-known acrylamide monomer solution for a concentration gel preparation (with a composition of 2.91% acrylamide, 0.09% bisacrylamide, 0.05% TEMED, and 0.03% APS) until the acrylamide buffer has a concentration of 100 mM.

First, the separation gel solution is injected into the gap between the two gel plates 1. Before the separation gel solution is injected, a polymerization initiator is added to the separation gel solution. The separation gel solution is injected in an amount so adjusted that the separation gel solution injected has a liquid surface (upper surface) below the top of the two gel plates 1.

When the injection is completed, the separation gel solution is left to stand for a predetermined time period to be gelated. While the separation gel solution is being gelated, distilled water (not shown) is poured on the liquid surface of the separation gel solution to form a layer by a conventionally well-known method. FIG. 2 illustrates the separation gel solution gelated (separation gel 4).

After the separation gel solution has been gelated, the layer of distilled water thereon is removed, and a concentration gel solution is poured on the liquid surface of the separation gel solution to form a layer. Before the concentration gel solution is injected, a polymerization initiator is added to the concentration gel solution. When the injection is completed, the separation gel solution is left to stand for a predetermined time period to be gelated. FIG. 2 illustrates the concentration gel solution gelated (concentration gel 5). The concentration gel solution in FIG. 2 has a liquid surface (upper surface) below the top of the gel plates 1. The present invention is, however, not limited to such an arrangement. The present invention may alternatively be arranged such that (i) the concentration gel solution is injected in such an amount as to have a liquid surface (upper surface) at a height equal to the height of the top of the gel plates 1 and that (ii) a conventionally well-known comb configured to form wells for sample application is then inserted into the concentration gel solution. When the injection is completed, the concentration gel solution is left to stand for a predetermined time period to be gelated.

The gel of Embodiment 1 for use in polyacrylamide gel electrophoresis may be prepared through the above procedure.

[3] Electrophoresis Apparatus

The description below deals with an embodiment of an electrophoresis apparatus according to the present invention, the embodiment being an automated two-dimensional electrophoresis apparatus 400 as an example.

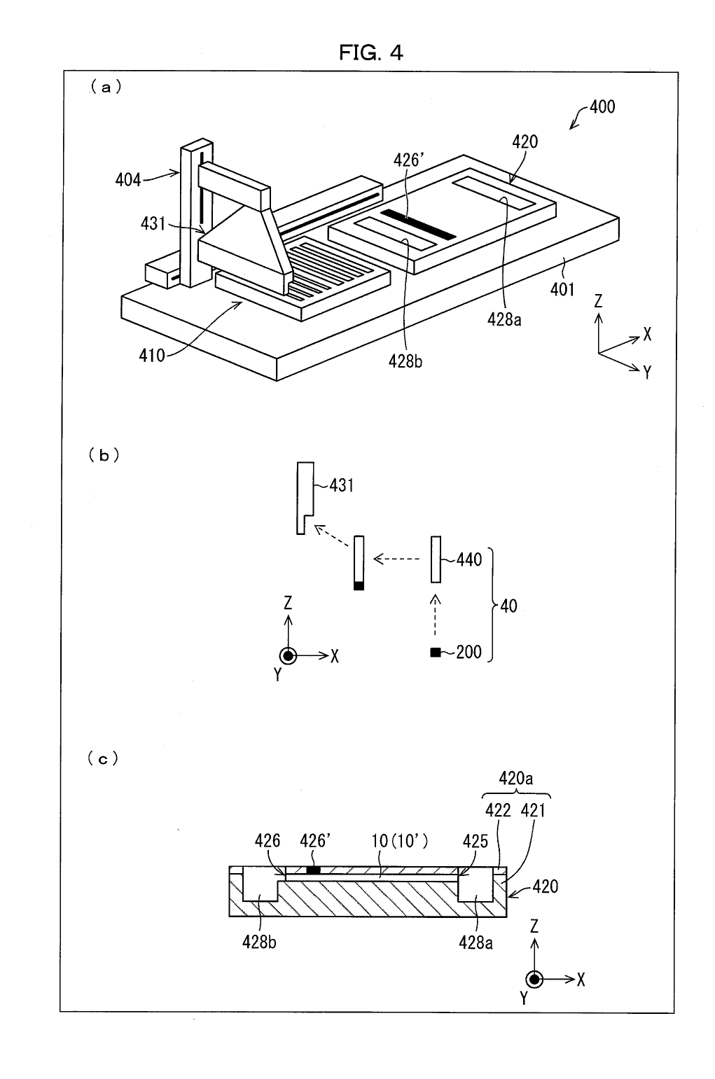

FIG. 4 illustrates a configuration of a main part of the automated two-dimensional electrophoresis apparatus 400 of Embodiment 1.

(a) of FIG. 4 is a perspective view of a main part of the automated two-dimensional electrophoresis apparatus 400, the perspective view illustrating a configuration of the main part. (b) of FIG. 4 illustrates how an isoelectric focusing gel 200 is bonded to a support arm 431 via a holding section 440. (c) of FIG. 4 provides a cross-sectional view and top view of a second-dimension electrophoresis section 420 for use in the automated two-dimensional electrophoresis apparatus 400, the cross-sectional view and top view illustrating a configuration of the second-dimension electrophoresis section 420.

The automated two-dimensional electrophoresis apparatus 400 of Embodiment 1 includes fixing means 401 as a stand, and on the fixing means 401, (i) a first-dimension electrophoresis section (first migration section) 410 including an isoelectric focusing instrument, (ii) a second-dimension electrophoresis section (second migration section) 420 for SDS-PAGE, (iii) a support arm 431, and (iv) driving means 404 configured to move the fixing means 401 and/or support arm 431 to change the respective positions relative to each other.

The automated two-dimensional electrophoresis apparatus 400 is operated as follows: A sample is first separated out by the first-dimension electrophoresis section 410 in a first direction (Y direction in FIG. 4). The buffer solution is then equilibrated. After that, the sample is separated out by the second-dimension electrophoresis section 420 in a second direction (X direction in FIG. 4). This operation can be carried out with the driving means 404 holding the support arm 431 in such a manner as to be capable of moving the support arm 431 in the X-axis direction and Z-axis direction.

(First-Dimension Electrophoresis Section)

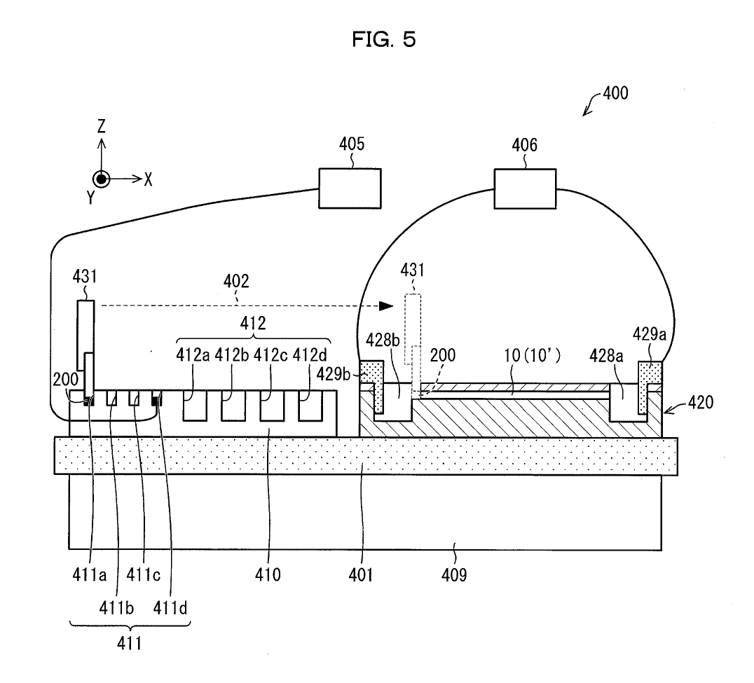

The first-dimension electrophoresis section 410 has a plurality of baths. The description below deals with the first-dimension electrophoresis section 410 further with reference to FIG. 5.

FIG. 5 is a cross-sectional view of the automated two-dimensional electrophoresis apparatus 400. The first-dimension electrophoresis section 410 includes a single insulator having a plurality of baths 411 and 412.

The plurality of baths include first reagent baths 411 each configured to store a reagent necessary for a step up to a first-dimension separation. The plurality of baths further include second reagent baths 412 each configured to store a reagent necessary after the first-dimension separation and before a second-dimension separation. Specifically, the first reagent baths 411 include a gel placement bath 411a, a sample bath 411b, a swelling bath 411c, and a first separation bath 411d as an isoelectric focusing instrument.

The second reagent baths 412 include a first equilibrating bath 412a, a dyeing bath 412b, a washing bath 412c, and a second equilibrating bath 412d. The first equilibrating bath 412a is preferably provided to store a buffer solution for (i) replacing the buffer solution used in the first-direction separation and (ii) increasing the efficiency of dyeing carried out after the first-direction separation. The washing bath 412c is preferably provided to store a buffer solution for washing away an excess of fluorescent dye that has become attached to the gel in the dyeing bath 412b, which stores fluorescent dye. The second equilibrating bath 412d stores a reagent preferable for a second-direction separation, for example, a reagent that reduces protein in the isoelectric focusing gel 200 or a reagent that bonds SDS to the protein. The second equilibrating bath 412d may alternatively store, for example, a buffer solution, a surface active agent, an enzyme, or an interaction substance depending on the method of the second-direction separation.

The description below deals with how the driving means 404 moves the support arm 431. The driving means 404 first moves the support arm 431 to a desired X position directly above the gel placement bath 411a, and then lowers the support arm 431 to a desired Z position. Next, the driving means 404 causes a gel-adhering holder 40 placed in the gel placement bath 411a to be adsorbed onto the support arm 431 with use of control means. The adsorption onto the support arm 431 can be controlled automatically with use of, for example, a solenoid valve. The driving means 404 moves the gel-adhering holder 40 adsorbed on the support arm 431 in the direction indicated by an arrow 402 in FIG. 5. This operation allows the isoelectric focusing gel 200 to be (i) subjected to a desired treatment in each bath of the first-dimension electrophoresis section 410 and (ii) subsequently transferred to the second-dimension electrophoresis section 420.

In other words, the first-dimension electrophoresis section 410 allows the following steps to be carried out: a step of placing a sample in the isoelectric focusing gel 200; a step of swelling the isoelectric focusing gel 200; a step of applying a voltage to the isoelectric focusing gel 200 to separate out the sample in a first direction; a step of dyeing the separated sample in the isoelectric focusing gel 200; and a step of equilibrating the separated sample with the environment of the second-dimension electrophoresis section 420. In the first-dimension electrophoresis section 410, addition of a sample to the isoelectric focusing gel and swelling of the isoelectric focusing gel 200 are carried out separately as described above, which increases the swelling rate.

The first separation bath 411d as an isoelectric focusing instrument is filled with a buffer solution necessary for isoelectric focusing (first-dimension separation). However, in a case where the swelling bath 411c stores a reagent containing a buffer solution necessary for the first-dimension separation, the first separation bath 411d does not need to be filled with a buffer solution necessary for the first-dimension separation. Applying a voltage to a pair of electrodes (not shown) with use of first voltage application means 405 separates out the sample in the isoelectric focusing gel 200 in the first separation bath 411d.

(Second-Dimension Electrophoresis Section)

The second-dimension electrophoresis section 420 is provided with the gel for use in polyacrylamide gel electrophoresis (SDS-PAGE gel) 10 described above. The SDS-PAGE gel 10 causes the separated sample in the isoelectric focusing gel 200 transferred from the first-dimension electrophoresis section 410 to be further separated out (SDS-PAGE) in a second direction different from the first direction.

The second-dimension electrophoresis section 420 includes an insulation section 420a that includes a lower insulating plate 421 (gel plate) and an upper insulating plate 422 (gel plate) placed on each other and that has a first buffer solution bath 428a and a second buffer solution bath 428b each formed through the upper insulating plate 422 at the lower insulation section. The lower insulating plate 421 has a gel-containing section 10′ facing the upper insulating plate 422 and configured to cover and contain the SDS-PAGE gel 10. The SDS-PAGE gel 10 contained in the gel-containing section 10′ is covered by the insulation section 420a (which includes the lower insulating plate 421 and the upper insulating plate 422) and can come into contact with the outside of the insulation section 420a at a first opening 425 and a second opening 426.

The first opening 425 and the second opening 426 respectively face the first buffer solution bath 428a and the second buffer solution bath 428b of the second-dimension electrophoresis section 420. For a sample separation in the second direction, the first buffer solution bath 428a and the second buffer solution bath 428b are filled respectively with a first buffer solution and a second buffer solution (that is, a solution containing a cathode buffer) that are in contact with the SDS-PAGE gel 10 in the gel-containing section 10′ at the first opening 425 and the second opening 426 respectively. The first buffer solution bath 428a and the second buffer solution bath 428b are provided respectively with a first electrode 429a and a second electrode 429b. Applying a voltage to the SDS-PAGE gel 10 with use of second voltage application means 406 via the first electrode 429a and the second electrode 429b causes a current to flow from the first opening 425 to the second opening 426. This current causes the separated sample in the isoelectric focusing gel 200 and a molecular weight marker to be developed from the second opening 426 to the first opening 425 and separated out.

The second buffer solution bath 428b is filled with a solution containing a cathode buffer that contains front ions (for example, chlorine ions) and trailing ions (for example, glycine or tricine). The cathode buffer containing front ions and trailing ions produces the effect of band concentration. The present invention may alternatively use, as its cathode buffer, a buffer containing no front ions or trailing ions (for example, a MOPS-based buffer or a MES-based buffer). Although a buffer containing no front ions or trailing ions does produce the effect described above of preventing heat generation, such a buffer fails to produce the concentration effect in a system other than a system containing trailing ions. The cathode buffer is thus preferably a buffer containing front ions and trailing ions. The cathode buffer has a buffer concentration adjusted to a value within the range of 25 mM to 50 mM. The gel for use in polyacrylamide gel electrophoresis has a buffer concentration adjusted to a value that falls within the range of 150 mM to 500 mM and that is higher than the buffer concentration of the cathode buffer. This allows for zone electrophoresis and produces the effect of sharpening the band of the protein.

The second opening 426 is shaped as illustrated in (c) of FIG. 4 such that the second buffer solution bath 428b has an opening through the upper insulating plate 422, the opening having a width larger than the width of the corresponding groove of the lower insulating plate 421. This difference in width, as illustrated in FIG. 5, allows the isoelectric focusing gel 200 on the gel-adhering holder 40 inserted through the second opening 426 to be in close contact with the SDS-PAGE gel 10, and consequently allows the sample in the isoelectric focusing gel 200 having been subjected to first-dimension electrophoresis to be successfully separated out by SDS-PAGE.

To cause the isoelectric focusing gel 200 to adhere to the SDS-PAGE gel 10, the insulation section 420a, which is configured to cover the SDS-PAGE gel 10, needs to have a portion at which the isoelectric focusing gel 200 and the SDS-PAGE gel 10 come into close contact with each other. The second opening 426 may serve as such a portion, or the second-dimension electrophoresis section 420 may further have, between the first opening 425 and the second opening 426, another opening 426′ to serve as such a portion.

For close contact between the isoelectric focusing gel 200 and the SDS-PAGE gel 10, the SDS-PAGE gel 10 preferably has an end exposed at the second opening 426, and more preferably, the exposed end of the SDS-PAGE gel 10 has a smooth surface for closer contact. In a case where the SDS-PAGE gel 10 does not have an end exposed at the second opening 426, an adhesion member (not shown) is simply needed at the second opening 426 for close contact between the isoelectric focusing gel 200 and the SDS-PAGE gel 10. Preferable examples of the adhesion member include, but are not limited to, (i) gels such as agarose and low-viscosity (approximately 1% to 3%) acrylamide and (ii) highly viscous liquids such as glycerin, polyethyleneglycol, and hydroxypropyl cellulose.

The first-dimension electrophoresis section 410, the second-dimension electrophoresis section 420, and the gel-adhering holder 40 are preferably detachably fixed to the fixing means 401, as the first-dimension electrophoresis section 410, the second-dimension electrophoresis section 420, and the gel-adhering holder 40 may be replaced for each sample. The first-dimension electrophoresis section 410, the second-dimension electrophoresis section 420, and the gel-adhering holder 40 are detachably fixed to the fixing means 401 not only by means of a vacuum adsorbing mechanism but also by means of a pinch-fixing mechanism, a magnetic force fixing mechanism, or an electrostatically adsorbing mechanism. The mechanism is, however, not limited to the above. In a case where the first-dimension electrophoresis section 410, the second-dimension electrophoresis section 420, and the gel-adhering holder 40 are detachably fixed to the fixing means 401 by means of a vacuum adsorbing mechanism, the first-dimension electrophoresis section 410, the second-dimension electrophoresis section 420, and the gel-adhering holder 40 are preferably fixed with use of a vacuum adsorbing plate.

The fixing means 401 may be superposed on cooling means 409 illustrated in FIG. 5 (for example, heat dissipation means) disposed directly below the fixing means 401. The use of the cooling means 409 allows the respective temperatures of the first-dimension electrophoresis section 410 and the second-dimension electrophoresis section 420 to be maintained during electrophoresis.

The electrophoresis apparatus of Embodiment 1 is an automated two-dimensional electrophoresis apparatus. The present invention is, however, not limited to a two-dimensional electrophoresis apparatus, and may of course be an electrophoresis apparatus configured to carry out SDS-PAGE only (including a typical SDS-PAGE apparatus).

The automated two-dimensional electrophoresis apparatus described above of Embodiment 1 is configured to have an SDS-PAGE gel 10 oriented along a horizontal plane (horizontally). The present embodiment may alternatively be configured to have an SDS-PAGE gel oriented along a vertical plane (vertically).

### Embodiment 2

The description below deals with another embodiment of the present invention. For convenience of description, any member of the present embodiment that is identical in function to a corresponding member described for the embodiment above is not described here.

Embodiment 1 described above is an embodiment in which an acrylamide buffer is covalently bonded to each of the separation gel and the concentration gel. The present invention is, however, not limited to such an arrangement. Embodiment 3 is, for example, arranged such that an acrylamide buffer is covalently bonded to the concentration gel only. Embodiment 3 is, in other words, arranged such that an acrylamide buffer is not covalently bonded to the separation gel.

Even in an embodiment in which an acrylamide buffer is covalently bonded to only the concentration gel out of the separation gel and the concentration gel as described above, the acrylamide buffer covalently bonded to the concentration gel does not move to the separation gel. The concentration gel thus continues to contain a buffer having a predetermined pKa even after passage of time. This makes it possible to prevent a change in the pH of the concentration gel and reduce a decrease in the concentration effect of the concentration gel. The above arrangement further prevents the buffer from moving in the concentration gel and prevents heat generation.

### Embodiment 3

The description below deals with another embodiment of the present invention. For convenience of description, any member of the present embodiment that is identical in function to a corresponding member described for any embodiment above is not described here.

Embodiment 1 described above is an embodiment in which an acrylamide buffer is covalently bonded to each of the separation gel and the concentration gel. The present invention is, however, not limited to such an arrangement. Embodiment 3 is, for example, arranged such that an acrylamide buffer is covalently bonded to the separation gel only. Embodiment 3 is, in other words, arranged such that an acrylamide buffer is not covalently bonded to the concentration gel.

Even in an embodiment in which an acrylamide buffer is covalently bonded to only the separation gel out of the separation gel and the concentration gel as described above, the acrylamide buffer covalently bonded to the separation gel does not move to the concentration gel. The concentration gel thus does not receive from the separation gel a buffer with a different pH even after passage of time. This makes it possible to prevent a change in the pH of the concentration gel and reduce a decrease in the concentration effect of the concentration gel. The above arrangement further prevents the buffer from moving in the separation gel and prevents heat generation.

[Recap]

A gel for use in polyacrylamide gel electrophoresis (10 for use in SDS-PAGE) according to a first aspect of the present invention is a gel for use in polyacrylamide gel electrophoresis, the gel including: a concentration gel 5; and a separation gel 4 having a pH adjusted to a value different from a value of a pH of the concentration gel 5, an acrylamide buffer being covalently bonded to at least one of the concentration gel 5 and the separation gel 4.

The above arrangement prevents the acrylamide buffer from being released from the gel to which the acrylamide buffer is covalently bonded. The covalently bonded acrylamide buffer refers to an acrylamide derivative that shows a buffering action.

The above arrangement can thus prevent the respective buffers of the concentration gel and the separation gel from becoming mixed with each other over time. The gel according to the first aspect of the present invention for use in polyacrylamide gel electrophoresis thus allows the concentration gel to maintain a concentration effect even after passage of time.

The above arrangement thus eliminates the need for a person who carries out migration to prepare a gel each time the person carries out migration. A maker of an electrophoresis apparatus, for example, can load a gel into the apparatus. The above arrangement can thus contribute to automation of electrophoresis.

Further, the above arrangement prevents the covalently bonded acrylamide buffer from moving through the gel even upon voltage application. This in turn prevents an excessive current from flowing through the gel and prevents undesirable heat generation. The above arrangement therefore allows for production of a gel for use in polyacrylamide gel electrophoresis which gel does not become swollen and allows for detection of a good electrophoresis separation pattern.

The above arrangement therefore makes it possible to provide a gel for use in polyacrylamide gel electrophoresis which gel causes a protein sample to be concentrated before being mixed with a separation gel, maintains a concentration effect over a longer time period, and prevents heat generation during migration.

Using, as a gel for electrophoresis, a neutral gel not including two layers may solve the above problems caused by a two-layer structure. However, a gel structured to include two layers, namely a separation gel and a concentration gel, as in the present invention produces a greater concentration effect and allows separation to be carried out better, thereby making it possible to detect a sharp band. Therefore, a gel of the present invention for use in polyacrylamide gel electrophoresis, which gel advantageously has a two-layer structure and also solves the above problems, is superior to conventional gels for electrophoresis.

In a second aspect of the present invention, a gel for use in polyacrylamide gel electrophoresis is preferably arranged such that, in the first aspect of the present invention, the acrylamide buffer is crosslinked to the concentration gel 5 and has a pKa within a range of 6.2 to 8.5. With this arrangement, glycine contained in the cathode buffer, which glycine has a low degree of dissociation, moves to the anode slowly, and the protein moving through the concentration gel is concentrated.

In a third aspect of the present invention, a gel for use in polyacrylamide gel electrophoresis is preferably arranged such that, in the first or second aspect of the present invention, the acrylamide buffer is crosslinked to the separation gel 4 and has a pKa within a range of 8.5 to 9.3. An acrylamide buffer having a pKa within the above range and being crosslinked to the separation gel allows for separation of the protein moving through the separation gel as a result of a molecular-sieve effect.

In a fourth aspect of the present invention, a gel for use in polyacrylamide gel electrophoresis is preferably arranged such that, in the first or third aspect of the present invention, the pH of the concentration gel 5 has been adjusted to a value within a range of 6.6 to 7.5; and the pH of the separation gel 4 has been adjusted to a value within a range of 8.4 to 8.8. This arrangement allows (i) the concentration gel to not separate out but concentrate the protein and (ii) the separation gel to separate out the concentrated protein excellently.

In a fifth aspect of the present invention, a gel for use in polyacrylamide gel electrophoresis may be arranged such that, in any one of the first to fourth aspects of the present invention, the gel is a gel for use in sodium dodecyl sulfate-polyacrylamide gel electrophoresis.

The above arrangement makes it possible to provide an SDS-PAGE gel that maintains a concentration effect over a longer time period, that prevents heat generation during migration, and that maintains a high separation resolution even after passage of time.

An electrophoresis apparatus (automated two-dimensional electrophoresis apparatus 400) according to a sixth aspect of the present invention is an electrophoresis apparatus, including a gel for use in polyacrylamide gel electrophoresis according to any one of the first to fourth aspects of the present invention; a cathode (second electrode 429b); an anode (first electrode 429a) provided opposite to the cathode (second electrode 429b) with respect to the gel for use in polyacrylamide gel electrophoresis; and a cathode buffer to be added to a portion of the gel for use in polyacrylamide gel electrophoresis which portion is on a side of the cathode (second buffer solution bath 428b).

The above arrangement makes it possible to provide an electrophoresis apparatus that enjoys the effects described above of the gel for use in polyacrylamide gel electrophoresis.

In a seventh aspect of the present invention, an electrophoresis apparatus is arranged such that, in the sixth aspect of the present invention, the cathode buffer includes a front ion and a trailing ion.

In an eighth aspect of the present invention, an electrophoresis apparatus may be arranged such that, in the sixth or seventh aspect of the present invention, the cathode buffer has a buffer concentration adjusted to a value within a range of 20 mM to 50 mM; and the gel has a buffer concentration adjusted to a value within a range of 150 mM to 500 mM. Allowing the gel for use in polyacrylamide gel electrophoresis to have a buffer concentration higher than that of the cathode buffer allows for zone electrophoresis.

In a ninth aspect of the present invention, an electrophoresis apparatus may, in any one of the sixth to eighth aspects of the present invention, further include: a first migration section (first-dimension electrophoresis section 410) configured to carry out a first-dimension electrophoresis; and a second migration section (second-dimension electrophoresis section 420) configured to carry out a second-dimension electrophoresis, wherein the second migration section includes the gel as a gel for electrophoresis.

The above arrangement allows the second migration section to include, as a gel for electrophoresis, the gel that produces the effects described above. The above arrangement can thus fully automate two-dimensional electrophoresis.

Conventional techniques have required a person who carries out migration to prepare an electrophoresis gel for the second migration section for the reason discussed above. This means that conventional techniques have only partially automated a two-dimensional electrophoresis apparatus and have required a person who carries out migration to prepare the gel himself/herself. The above arrangement, in contrast, allows a gel to be placed in the apparatus (well) in advance of carrying out of migration. The above arrangement thus only requires a person who carries out migration to, for example, adjust a sample, and makes it possible to automate the whole operation for electrophoresis with use of the apparatus.

The present invention is not limited to the description of the embodiments above, but may be altered in various ways by a skilled person within the scope of the claims. Any embodiment based on a proper combination of technical means disclosed in different embodiments is also encompassed in the technical scope of the present invention. Further, combining technical means disclosed in different embodiments can provide a new technical feature.

### EXAMPLES

### 1. Pretreatment of Sample Protein

A sample protein was prepared from a mouse liver tissue. First, 0.4 g of a sample was weighed out from a mouse liver tissue in such a manner that blood vessels and blood boils were avoided as much as possible, and was put into a 5-mL glass Teflon (registered trademark) homogenizer having been cooled on ice. To the sample in the homogenizer, (i) a dissolving buffer (50 mM tris HCl [pH 7.6], 20% glycerol, and 0.3M NaCl) cooled to 4° C. and having an amount (2 mL) 5 to 6 times the amount of the sample and (ii) a protease inhibitor cocktail were added, and the mixture was homogenized on ice (3000 rpm to 4000 rpm). Next, the mixture was centrifuged at 1000×g at 4° C. for minutes. After the supernatant was recovered, the supernatant was centrifuged at 16000×g at 4° C. for 30 minutes. The supernatant was recovered again, and an operation was carried out for determining the amount of protein to calculate the concentration. After that, the mixture was preserved at −80° C.

Subsequently, the protein was purified by deionization and concentration through acetone precipitation. First, a protein solution sample prepared from a mouse liver tissue was charged into a 1.5- to 2.0-mL microtube. Cold acetone (−20° C.) having an amount 8 to 9 times the amount of the protein solution sample was added to the sample in the microtube, and the temperature of the solution sample was kept at −20° C. for approximately 2 hours. Subsequently, the sample was centrifuged at 14000×g at 4° C. for 10 minutes. The supernatant (acetone fraction) was discarded, and the sample was left to stand for 2 to 3 minutes with the tube lid open to evaporate the acetone.

### 2. Preparation of SDS-PAGE Gel 10 to which Buffer is Covalently Bonded

An SDS-PAGE gel (10) was prepared with use of a gel preparing instrument illustrated in FIG. 1. First, two glass plates (1) with 1-mm spacers and a gasket in-between were fixed with clips (2). An acrylamide monomer solution (9.7% acrylamide, 0.3% bisacrylamide, 375 mM Tris-HCl [pH 8.8], 0.1% TEMED, and 0.05% APS) containing a tris buffer solution with a pH of 8.8 was injected into a space between the glass plates from an injection tube (3) to fill approximately 70% of the space. Then, water was poured on the surface layer to form a layer, and polymerization was carried out at room temperature for 30 minutes. This formed a separation gel.

Next, the water was removed. Onto the separation gel, an acrylamide monomer solution (2.91% acrylamide, 0.09% bisacrylamide, 100 mM acrylamide buffer [pKa 6.8], 0.05% TEMED, and 0.03% APS) containing an acrylamide buffer having a pKa of 6.8 was injected. A flat comb was placed on top to prevent the surface of the acrylamide monomer solution from coming into contact with air, and the acrylamide monomer solution was polymerized at room temperature for approximately 2 hours. This formed a concentration gel 5. The above procedure prepared a two-layer SDS-PAGE gel having a concentration gel and a separation gel (see FIG. 2).

### 3. Two-Dimensional Electrophoresis: Comparison with Single-Layer Gel

Two-dimensional electrophoresis was carried out with use of Auto 2D produced by Sharp Manufacturing Systems Corporation. As an Example, the two-layer SDS-PAGE gel prepared in item 2 above was used, while as a Comparative Example, a commercially available single-layer (pH 8.8) SDS-PAGE gel prepared to have improved preservability was used.

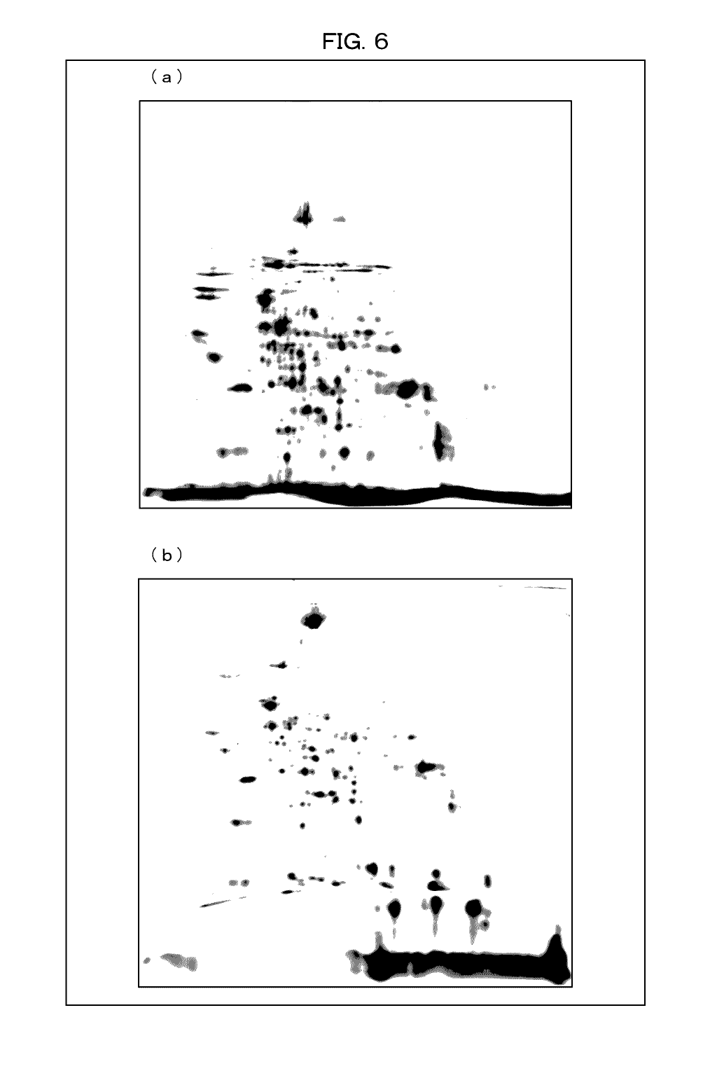

First, two-dimensional electrophoresis was carried out with use of, as a sample, the soluble protein prepared from a mouse liver in item 1 above. An aqueous solution containing 25 mM tris base, 192 mM glycine, and 0.1% SDSD was used as a cathode buffer. FIG. 6 shows the results. The SDS-PAGE gel according to the Example ((a) of FIG. 6) allowed for sharp detection of spots in a molecular weight direction as compared with the SDS-PAGE gel according to the Comparative Example ((b) of FIG. 6).

Further, two-dimensional electrophoresis was carried out with use of an antibody (Trastuzumab) as a sample. A first-dimension electrophoresis was carried out under the following conditions:

Step 1: 200 V, 5 minutes, constant

Step 2: 1000 V, 5 minutes linear gradient

Step 3: 1000 V, 5 minutes, constant

Step 4: 4000 V, 10 minutes linear gradient

Step 5: 4000 V, 10 minutes, constant

Step 6: 7000 V, 10 minutes linear gradient

Step 7: 7000 V, 20 minutes, constant

Then, a second-dimension electrophoresis was carried out as follows:

Step 1: 10 mA, 10 minutes, constant

Step 2: 20 mA, 35 minutes

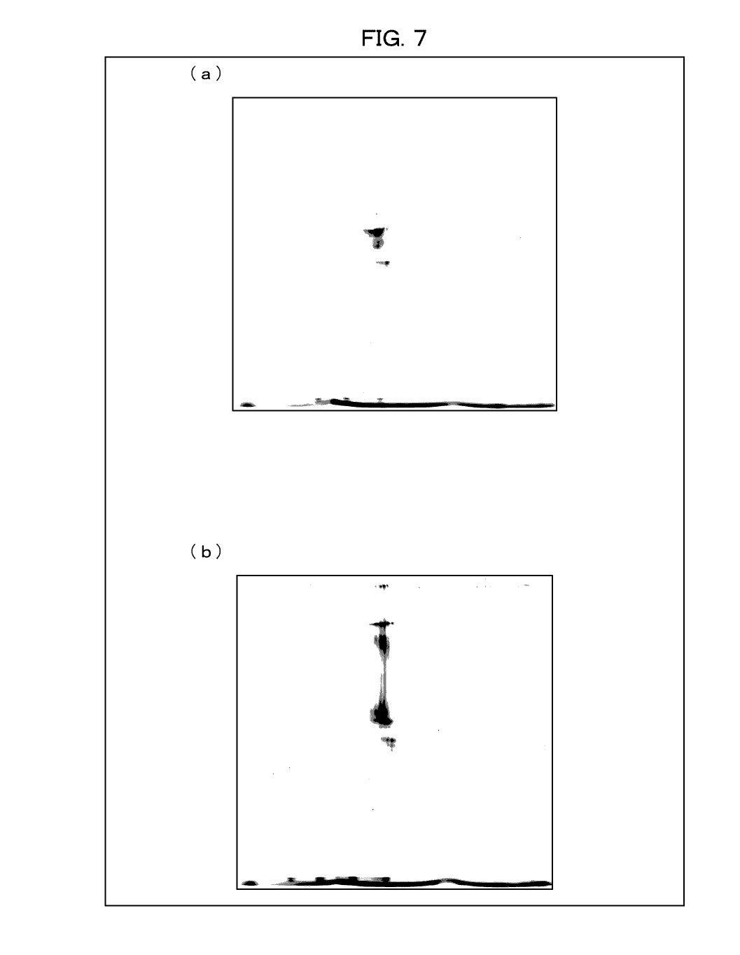

FIG. 7 shows the results of the two-dimensional electrophoresis. The SDS-PAGE gel according to the Comparative Example ((b) of FIG. 7) showed a phenomenon of a vertically extending spot. This was due to the fact that the antibody under the non-reducing conditions was an extremely large molecule with approximately 160 kDa. The SDS-PAGE gel according to the Example ((a) of FIG. 7), even with use of an antibody as a sample, prevented the phenomenon of a vertically extending spot as a result of the concentration effect of the concentration gel ((a) of FIG. 7).

### INDUSTRIAL APPLICABILITY

The present invention is applicable to an electrophoresis apparatus for SDS-PAGE and a two-dimensional electrophoresis apparatus as well as, for example, research and development for drugs. The present invention can further find practical application in a medical device for diagnosis.

### REFERENCE SIGNS LIST

1 gel plate
2 clip
3 tube
4 separation gel
5 concentration gel
10 SDS-PAGE gel (gel for use in polyacrylamide gel electrophoresis)
10′ gel-containing section
40 gel-adhering holder
200 isoelectric focusing gel
400 automated two-dimensional electrophoresis apparatus
410 first-dimension electrophoresis section (first migration section)
411 first reagent bath
412 second reagent bath
420 second-dimension electrophoresis section (second migration section)
421 lower insulating plate
422 upper insulating plate
428a first buffer solution bath
428b second buffer solution bath
429a first electrode
429b second electrode

1. A gel for use in polyacrylamide gel electrophoresis,
the gel comprising:
a concentration gel; and
a separation gel having a pH adjusted to a value different from a value of a pH of the concentration gel,
an acrylamide buffer being covalently bonded to at least one of the concentration gel and the separation gel.

2. The gel for use in polyacrylamide gel electrophoresis according to claim 1,
wherein
the acrylamide buffer is crosslinked to the concentration gel and has a pKa within a range of 6.2 to 8.5.

3. The gel according to claim 1,
wherein
the acrylamide buffer is crosslinked to the separation gel and has a pKa within a range of 8.5 to 9.3.

4. The gel according to claim 1,
wherein:
the pH of the concentration gel has been adjusted to a value within a range of 6.6 to 7.5; and
the pH of the separation gel has been adjusted to a value within a range of 8.4 to 8.8.

5. The gel according to claim 1,
wherein
the gel is a gel for use in sodium dodecyl sulfate-polyacrylamide gel electrophoresis.

6. An electrophoresis apparatus, comprising:
a gel for use in polyacrylamide gel electrophoresis according to claim 1;
a cathode;
an anode provided opposite to the cathode with respect to the gel for use in polyacrylamide gel electrophoresis; and
a cathode buffer to be added to a portion of the gel for use in polyacrylamide gel electrophoresis which portion is on a side of the cathode.

7. The electrophoresis apparatus according to claim 6,
wherein
the cathode buffer includes a front ion and a trailing ion.

8. The electrophoresis apparatus according to claim 6,
wherein:
the cathode buffer has a buffer concentration adjusted to a value within a range of 20 mM to 50 mM; and
the gel has a buffer concentration adjusted to a value within a range of 150 mM to 500 mM.

9. The electrophoresis apparatus according to claim 6, further comprising:
a first migration section configured to carry out a first-dimension electrophoresis; and
a second migration section configured to carry out a second-dimension electrophoresis,
wherein
the second migration section includes the gel as a gel for electrophoresis.
